(19) United States
(12) Patent Application Publication
(10) Pub. No.: US 2010/0311626 A1
(43) Pub. Date: Dec. 9, 2010

(54) CONTACT LENS CLEANER

(76) Inventor: Sven Reichwagen, Bromskirchen (DE)

Correspondence Address: BERLINER & ASSOCIATES, 555 WEST FIFTH STREET, 31ST FLOOR, LOS ANGELES, CA, 90013, US

(21) Appl. No.: 12/742,238

(22) PCT Filed: Dec. 31, 2007
(86) PCT No.: PCT/EP2007/011475

§ 371 Date: Aug. 26, 2010

(30) Foreign Application Priority Data
Dec. 29, 2006 (DE) 10 2006 062 616.8

(51) Int. Cl. C11D 3/48

(52) U.S. Cl. 510/115

(57) ABSTRACT

The invention relates to a contact lens cleaning agent which contains 0.001 to 5% w/w of an organic peroxy acid as well as to the use of organic peroxy acids for contact lens cleaning purposes.

The invention relates to a contact lens cleaner based on organic peroxy carbonic acids.

The cleaning of contact lenses is a must for all persons wearing contact lenses. If contact lenses are poorly cleaned serious eye infections may develop. The cleaning liquids themselves may be harmful if they are allowed to come into contact with the eye and, furthermore, they may cause irritation of the user's skin, especially when in contact with the hands.

Customary cleaning liquids more often than not contain hydrogen peroxide which has both disinfective and cleaning properties. Aside from disinfection, H₂O₂ also has a significant cleaning effect due to the fact that it generates active oxygen.

Nevertheless, a multitude of microorganisms is protected to a lesser or greater extent by catalases against the effects of H₂O₂. Although the growth of such microorganisms may still be inhibited or they may even be killed by H₂O₂ quite high concentrations are needed to achieve this goal. Such high concentrations on the other hand have a highly irritating effect on tissue so that the liquid must not come into contact with eyes or skin of the user. Since this cannot always be reliably warranted lower H₂O₂ concentrations are frequently used that do not have the desired disinfectant effect.

Problems encountered with lens cleaning and care, especially when soft contact lenses are concerned, have greatly contributed to the widespread acceptance of lenses intended for daily and monthly wear. Due to these lenses' limited durability or period of wear hygienic problems are alleviated by discarding the lenses before any precarious accumulation of microbial germs can develop on the surface of the lens. However, said lenses for daily or monthly wear are a relatively demanding substitute for the continuous wear lenses, in particular in terms of the cost involved.

Bearing all this in mind, a contact lens cleaning agent is needed that counteracts the microbial contamination of contact lenses in a reliable manner, can be simply disposed of through rinsing, and reliably prevents irritation of eyes and skin.

This objective is reached with the contact lens cleaning agent based according to the invention on organic peroxy carbonic acids.

It has been found that organic peroxy acids of extraordinarily low concentration have a strong microbicidal effect. Microbicidal in this context means that they reliably destroy bacteria, viruses, fungi, and other lower living organisms. For this purpose, it will be sufficient for the inventive contact lens cleaning agent to be provided in an aqueous solution of a concentration ranging between 0.001 and 5% w/w, preferably of a concentration ranging between 0.01 and 1 w/w and in particular of a concentration ranging between 0.05 and 0.5% w/w.

Suitable organic peroxy acids are basically all organic carbonic acids, whether aliphatic or aromatic, saturated or unsaturated, with the use of performic acid and peracetic acid considered, despite good results achieved, to be of lesser usefulness for practical reasons due to their aggressive action and pungent odor. Nevertheless, based on the relevant content of peroxy carbonic acid a content of up to 10% w/w of peracetic acid may be advantageous. Preferred are in particular those peroxy carbonic acids that comprise a minimum of 3 C-atoms. In the event of monocarbonic acids these are in particular the peroxy acids alkylic, alkenylic and arylcarbonic acids, for example of propionic acid, sorbic acid and benzoic acid. Preferred are furthermore the peroxides of such carbonic acids that have at least two carboxylic functions, i.e. of saturated and unsaturated dicarbonic acids, for example maleic acid, fumaric acid, glutaric acid, succinic acid, the phthalic acids and the like. Particularly suited for the intended purpose are also the peroxy compounds of complex-forming organic carbonic acids, such as for example citric acid, tartaric acid, malic acid, lactic acid, mandelic acid and the like which as a rule have another hydroxy and/or carboxylic function in addition to the first carboxylic function. Mixtures of different organic peroxy acids may of course also be employed. Carbonic acids with several hydrophilic functions are as a rule better soluble in water than monofunctional ones and are suited to bind traces of heavy metal that might cause peroxides to suffer premature decomposition.

The peroxy carbonic acids required for the contact lens cleaner according to the invention are provided in a manner known per se. Said acids may, for example, be obtained from the respective precursor compounds, i.e. carbonic acids or their anhydrides or chlorides using peroxy compounds such as hydrogen peroxide, alkaline peroxides or salts of Caro's acid. Moreover, another possibility is the decomposition of diacyl peroxides with water or acid, for example of dibenzoyl peroxide.

The inventive contact lens cleaning agent may be provided both in the form of a ready-to-use solution and as a liquid concentrate. In this case the cleaner as such or in a specifically admeasured amount is filled into the contact lens cleaning bowl and, if necessary, topped up with tap water. In this case, the above mentioned effective concentration of 0.001 to 5% w/w, preferably 0.01 to 1% w/w and in particular 0.05 to 0.5% w/w based on the cleaning solution as a whole should be adhered to. The cleaning agent may contain surface-active substances.

After use, the inventive contact lens cleaning agent may readily be disposed of and discharged down the drain. It will be sufficient to thoroughly rinse the contact lenses with water. Skin that has come into contact with the cleaner can also be washed or rinsed off with water.

In accordance with another embodiment of the invention the contact lens cleaning agent is provided in the form of a combination comprising an organic acid and an H₂O₂ generating compound, with the H₂O₂ generating compound having a 2- to 6-fold molar excess over the organic acid. In lieu of the organic acid its salts or anhydrides may be employed as well.

Suitable for use as organic acids are the above named acids.

As a rule, the H₂O₂ generating compound is a simple peroxo compound, in particular peroxosulfate, peroxodisulfate, percarbonate, metal peroxide or urea peroxide. In particular, the salts of peroxo compounds are of advantage here when a salt form can be generated, for example the alkaline or ammonium salts of the peroxosulfuric acid or peroxodisulfuric acid. In case of metal peroxides especially alkaline peroxides are suited, as far as percarbonate is concerned sodium carbonate is used containing hydrogen peroxide attached in the form of water of crystallization. Especially preferred are inorganic peroxo salts, and among which potassium caroate, 2 KHSO₅×KHSO₄×K₂SO₄, is to be named in particular.

Moreover, diacyl peroxides, and in particular dibenzoyl peroxide can be employed for the production of peroxy carbonic acids in tablet form. Dibenzoyl peroxide reacts with water, acids and all forms of compounds liberating hydrogen ions to form peroxybenzoic acid. Dibenzoyl peroxide in solid form is commercially available and, especially in phlegmatized form, can be pressed into tablets.

The use of organic acids, their salts or anhydrides and the H₂O₂ generating compounds enable the contact lens cleaning agent to be produced in the form of tablets. In the event the original acid is available in liquid form it is deemed expedient to use it as a salt or in the form of a solid anhydride. Otherwise, the acids in solid form may be used as well. The salts of the H₂O₂ generating compounds are available in solid form anyway and in this state also withstand decomposition. A tablet containing these agents may comprise surfactants and customary carrier and auxiliary substances and, for example, be made available in a blister pack.

As a rule, the H₂O₂ generating compound is provided with 2- to 6-fold molar excess over the organic acid, its salt or its anhydride. After the acid has been converted to peroxy carbonic acid this also makes sure peroxide remains and serves to generate active oxygen and improve the cleaning effect. Especially preferred is a 4- to 5-fold excess of an H₂O₂ generating compound.

If this variant of the contact lens cleaner is made available in tablet form both components of the tablet co-exist in stable form. When transferred to an aqueous solution minor amounts, if any, of organic acid will form so that a pH value is obtained that is outside the strongly acidic range. In actual fact, formulations may be produced that are more or less in the neutral range. In accordance with the invention such formulations are preferred as they provide for the peroxy constituents of the aqueous cleaning solution produced as proposed by the invention to decompose rather quickly. If using, for example, citric acid and potassium caroate as constituents of a tablet virtually nothing but citric acid and potassium sulfate remain in the cleaning solution after the cleaning process has been completed which may be disposed of without second thoughts.

The tablets may contain tablet-forming substances or agents and the like in customary amounts. Moreover, the tablets may contain up to 10% w/w of an acetic acid salt, preferably sodium acetate. Sodium acetate contributes to the cleaning effect of the solution and may improve dissolution of the peroxy carbonic acid.

The tablet should contain the required constituents, i.e. the organic acid or its derivatives and the H₂O₂ generating compound in an amount capable of producing in the cleaning solution to be used a peroxy carbonic acid concentration of between 0.001 and 5% w/w, preferably between 0.01 and 1% w/w and in particular between 0.05 and 0.5% w/w.

The invention eventually relates to the use of organic peroxy acids and peroxy compounds as per the definition hereinbefore for the cleaning of contact lenses and/or for the production of a cleaning agent for contact lenses.

Finally, cleaning liquid and tablet may be provided in a kit together with a deactivating agent which may be a pyruvate or thiosulfate tincture or tablet or a platinum wire screen or such a disk.

### Test Conditions Acc. to DIN

### 1. General

Test procedures according to DIN EN ISO 14729 “Ophthalmic optics—Contact lens care products—Microbiological requirements and test methods for products and regimens for hygienic management of contact lenses”;
Test germs:

| | |
|---|---|
| Pseudomonas aeruginosa | ATCC 9027 |
| Staphylococcus aureus | ATCC 6538 |
| Serratia marcescens | ATCC 13880 |
| Candida albicans | ATCC 10231 |
| Fusarium solani | ATCC 36031 |

Dilution medium: isotonic common salt solution; alternatively mineral water, tap water
Concentration in the solution to be applied:
   0.001%-7% liquid cleaning agent
   0.001%-13% solid cleaning agent
Selection of inactivators:
   Sodium thiosulfate or pyruvate as short- or long-term inactivating agent
   Platinum disk as long-term inactivating agent
Buffer: Phosphate buffer (NaH₂PO₄, Na₂HPO₄, Na₃PO₄) adjusted to a pH value in the neutral range

### EXAMPLE 1

50 g of citric acid and 352 g of potassium peroxodisulfate in powder form are mixed with each other and pressed into tablets each weighing 2 g.

A tablet dissolved in 100 ml of tap water yields an abt. 0.25% solution of peroxy citric acid. The excess of potassium peroxodisulfate (5 mol of potassium peroxodisulfate per mol of citric acid) leads to a slowly developing and longer lasting oxygen formation. The cleaning process is completed within a few minutes.

### Tests Conducted:

Using the microorganisms S. aureus ATTC 6538, E. coli NCTC 10538, P. merabilis ATCC 14153, P. aeruginosa ATCC 15442, E. hirae ATCC 10541 and C. albicans ATCC 10231 (2 to 5×10⁹ KbE in each case) inactivation was achieved within 5 minutes with the peroxy carbonic acid concentration being 0.5%.

### EXAMPLE 2

### 2. Formulation of a Liquid Contact Lens Cleaning Agent

### Composition

5 g Tartaric acid
1 g Benzoic acid
1 g Glutaric acid
1 g Maleic acid
1 g Acetic acid
0.5 g Succinic acid
6.5 g Citric acid
16.5 g H₂O₂ (35%)
   topped up with distilled water to 115 ml
   Tests: Quantitative suspension test acc. to DIN EN ISO 14729
At 6%—no germs were found after 5 min and 30 min
At 4%—no germs were found after 2 hours

### EXAMPLE 3

### 3. Formulation of a Solid Contact Lens Cleaning Agent

### Composition:

5 g Tartaric acid
1 g Benzoic acid
1.5 g Glutaric acid
1 g Maleic acid
3 g Citric acid
3.5 g TAED
26 g Urea peroxide

Weight of tablet: 0.2 g-1.2 g dissolved in 2-5 ml of diluting medium

Tests: Quantitative suspension test acc. to DIN EN ISO 14729
At 5%—no germs were found after 6 hours
At 9%—no germs were found after 3 hours

1. Contact lens cleaning agent containing 0.001 to 5% w/w of organic peroxy carbonic acid.

2. Contact lens cleaning agent according to claim 1, characterized in that the organic peroxy acid has at least 3 C atoms.

3. Contact lens cleaning agent according to claim 1, characterized in that the organic peroxy acid has at least one additional hydroxy and/or carboxy function.

4. Contact lens cleaning agent according to claim 1, characterized in that said cleaner contains a peroxy acid of citric acid, tartaric acid, malic acid, sorbic acid, benzoic acid, maleic acid, glutaric acid, succinic acid or mixtures thereof.

5. Contact lens cleaning agent according to claim 1, characterized in that said cleaner additionally contains a salt of acetic acid.

6. Contact lens cleaning agent according to claim 1, characterized in that said cleaner contains 0.01 to 1% w/w of organic peroxy acid.

7. Contact lens cleaning agent according to claim 1, characterized in that said cleaner contains free H₂O₂, preferably with 1- to 5-fold molar excess over the peroxy carbonic acid.

8. Contact lens cleaning agent in solid form, containing an organic carbonic acid, its salt or its anhydride together with an H₂O₂ generating compound, with said H₂O₂ generating compound being provided in 2- to 6-fold molar excess over the organic carbonic acid, its salt or its anhydride.

9. Contact lens cleaning agent according to claim 8, characterized in that the organic carbonic acid, its salt or anhydride has at least three C-atoms.

10. Contact lens cleaning agent according to claim 8, characterized in that the organic carbonic acid has at least one additional hydroxy and/or carboxy function.

11. Contact lens cleaning agent according to claim 8, characterized in that the H₂O₂ generating compound is a peroxosulfate, peroxodisulfate, percarbonate, metal peroxide or urea peroxide.

12. Contact lens cleaning agent according to claim 8, characterized in that the H₂O₂ generating compound is provided in a 4- to 5-fold molar excess over the organic acid, its salt or its anhydride.

13. Contact lens cleaning agent in solid form, containing a diacyl peroxide, in particular dibenzoyl peroxide, if thought expedient together with a hydrogen ions generating compound and/or a peroxo compound.

14. Contact lens cleaning agent according to claim 8 or 13 in the form of a tablet.

15. Use of an organic peroxy carbonic acid or a diacyl peroxide for the production of an aqueous solution for contact lens cleaning purposes.

16. Use according to claim 15, characterized in that the organic peroxy acid is applied in an amount of between 0.001 and 5% w/w in relation to the cleaner solution.

17. Use according to claim 15, characterized in that the organic peroxy acid is produced in situ with the aid of a tablet containing the relevant organic acid, its salt or its anhydride together with an H₂O₂ generating compound.

18. Use according to claim 16, characterized in that the organic peroxy acid is produced in situ with the aid of a tablet containing a diacyl peroxide, in particular dibenzoyl peroxide.
